(19) United States
(12) Patent Application Publication
(10) Pub. No.: US 2012/0186138 A1
(43) Pub. Date: Jul. 26, 2012

(54) INFLATABLE PORTABLE TREATMENT DEVICE

(76) Inventors: James Bell, Glencoe, IL (US); Warrick Bell, Northbrook, IL (US); Brian P. Hirsch, Chicago, IL (US); Ching-Yao Yeh, Shanghai (CN)

(21) Appl. No.: 13/344,086

(22) Filed: Jan. 5, 2012

Related U.S. Application Data
(60) Provisional application No. 61/435,486, filed on Jan. 24, 2011.

(51) Int. Cl. A01M 13/00

(52) U.S. Cl. 43/125; 43/124

(57) ABSTRACT

An inflatable, portable treatment device for the treatment of an item, such as fumigation and/or extermination of vermin creature. The item is to be placed in an inner area of the inflatable bladder. A fan positioned in the inner area may propel a chemical agent in the interior area. According to certain embodiments, a heating element may increase the temperature of the interior area. A power cord for the fan or heating element may be plugged into an electrical extension assembly that is connected to the treatment device and is configured to prevent or minimize gas and/or fumigant and/or pesticide vapor from escaping from the inner area. The opening may be sealed by closing an air seal. An airway assembly may be attached to the treatment device to deliver gas from a gas delivery source, such as a blower or gas tank, into the interior area.

### RELATED APPLICATIONS

This application claims priority to U.S. Provisional Application No. 61/435,486, having a filing date of Jan. 24, 2011, which is incorporated herein by reference in its entirety.

### BACKGROUND OF THE INVENTION

Embodiments of the present invention generally relate to chemical and non-chemical applications, including fumigation and extermination, and particularly to an inflatable, portable sealable enclosed treatment apparatus and method for using an inflatable, portable apparatus for the treatment of an item, such as, for example, fumigation and/or extermination of vermin creatures.

Chemical applications, such as fumigation and extermination, among others, are often used to exterminate pests or for disinfection. Such applications typically involve the use of gas, smoke, fumes, vapor, or other ultra-low volume inseted chemical that may contain a lethal or harmful chemical to an item or area. The lethal or harmful chemical used may be selected for the particular application, such as, for example, to cause the suffocation, or poisoning of insects, rodents, or other animals (referred to herein collectively as “vermin creatures”).

Because chemical or gas applications such as fumigation and extermination, among others, may involve the application of chemicals or gas that are lethal or harmful to humans, such applications often require significant preparation that is intended to eliminate or limit exposure to these chemicals both during and after the application process. For example, prior to fumigation and/or extermination, humans, pets, and plants may need to be removed from the area that is to be treated. Food and medications may also need to be removed prior to such application of harmful or lethal chemicals. Additionally, the chemicals or gas used in such applications may need to remain in the treated item(s) or area for a set number of hours, which may preclude the use of the treated item or area during that time period. And even after the chemicals or gas have remained in the item(s) or area for a set period of time, additional time and effort may be required to remove the chemicals or gas from the treated item(s) or area, such as by aeration, before use of the treated items and/or area may resume.

The inconvenience associated with chemical applications such as fumigation and extermination may be exacerbated by the exposure of item(s) and/or areas in proximity to the item or area that is being treated by such applications. Specifically, because such applications may involve the use of harmful chemicals in smoke, fumes, or vapor, items or areas adjacent to the item(s) or area being treated may also be exposed to those same chemicals as the smoke, fumes, or vapor spreads beyond the treated items and/or areas. For example, the fumigation of a couch to exterminate vermin creature present or residing therein, may render the entire room in which the couch is located uninhabitable and the other items in that room unusable during the treatment processes. Further, after completion of the treatment process, additional time and effort may be required to remove the harmful chemical agent from these other exposed and effected items or areas before they may be safely used or inhabited.

### BRIEF SUMMARY OF THE INVENTION

Once aspect of the invention is an inflatable, portable treatment device having an inflatable bladder. The inflatable bladder includes an interior area that is configured to receive the placement of one or more items to be treated, such as, for example, fumigated and/or treated for the extermination of vermin creatures. The treatment device also includes an airway assembly that is operably attached to the inflatable bladder. The airway assembly includes a connector, at least a portion of the connector being configured for attachment to a hose that delivers gas, such as air or carbon dioxide, among others, to the airway assembly. The airway assembly is configured so that the gas delivered to the airway assembly passes through the airway assembly and into the interior area.

The treatment device may also include an electrical extension assembly operably attached to the inflatable bladder. The extension assembly may include a socket and an extension cord. The extension assembly may be configured to prevent the escape of gas from the interior area of the inflatable bladder through the extension assembly when the inflatable bladder is inflated.

Additionally, a fan may be operably positioned in the interior area of the inflatable bladder. The socket of the extension assembly is configured to receive the insertion of at least part of a power cord of the fan. The fan may be positioned to circulate a fumigant and/or pesticide vapor or chemical agent about the interior area when the inflatable bladder is inflated.

According to another aspect of the invention, an inflatable, portable treatment device includes an inflatable bladder having an opening and an interior area. The opening may be configured to allow for the placement of an item(s) to be treated in the interior area. The opening may include an air seal that is configured to close the opening so as to prevent the passage of gas from the interior area through the opening when the inflatable bladder is inflated.

The treatment device may also include an airway assembly that is operably connected to the inflatable bladder. The airway assembly may have a connector. At least a portion of the connector may be configured for attachment to a hose that is used to deliver gas through the airway assembly and into the interior area of the inflatable bladder.

Another aspect of the present invention is an inflatable, portable treatment device that includes an inflatable bladder having an opening and two or more walls, such as, for example, an upper wall, and a lower wall. The upper and lower walls may be configured to create an inner area between the upper and lower walls. The opening may be configured to allow for the placement of an item to be treated in the inner area. The opening may include an air seal that is configured to close the opening so as to prevent the passage of gas from the interior area through the opening when the inflatable bladder is inflated.

The treatment device may also include an airway assembly that is operably connected to the inflatable bladder. The airway assembly may include a connector and an outer adapter. The outer adapter may be configured to receive the removable insertion of the connector. The outer adapter may also be configured to receive the placement of a cap on the outer adapter, the cap being configured to prevent the passage of gas from the interior area through the outer adapter when the inflatable bladder is inflated. At least a portion of the connector may be configured for attachment to a hose that is used to deliver gas through the airway assembly and into the interior area.

Another aspect of the invention is a portable treatment kit that includes at least one inflatable bladder. The at least one inflatable bladder, such as, for example, two inflatable bladders, has an interior area and an opening. The interior area is configured to receive the placement of an item to be treated. The opening is closed by an air seal that prevents the passage of gas from the interior area through the opening when the inflatable bladder is inflated. The seal has one or more ridges and one or more mating recesses that, when mated, provide an air seal. The kit may also include a hose that is used in the delivery of gas to the interior area at least when the inflatable bladder is being inflated. The kit further includes an airway assembly attached to the inflatable bladder. The airway assembly has a connector configured for connection of the airway assembly to the hose. The airway assembly is configured to pass gas delivered by the hose to the interior area. According to certain embodiments, the kit may also include an electrical extension assembly, a fan, a heater fan, a heating element, a chemical agent, and/or a felt pad.

### BRIEF DESCRIPTION OF SEVERAL VIEWS OF THE DRAWINGS

FIG. 1 is a perspective view of an inflatable portable treatment device according to an embodiment of the present invention that is shown encapsulating a couch.

FIG. 2 illustrates a perspective view of a section of mating portions of an air seal along the opening of the inflatable bladder of FIG. 1.

FIG. 2a illustrates a perspective view of a sealer clamp for use in mating portions of an air seal along the opening of the inflatable bladder of FIG. 1 to form an air seal.

FIG. 3 is a perspective view of a section of the inflatable portable treatment device of FIG. 1 showing a capped outer adapter and an extension assembly.

FIG. 4a illustrates a perspective view of a blower operably connected to the airway assembly of FIG. 3.

FIG. 4b illustrates a perspective view of an embodiment of a connector to connect the hose to a blower, as shown in FIG. 4a.

FIG. 4c illustrates a perspective view of an embodiment of a gas connector to connect a gas tank and a hose for delivery of a compressed gas to the inflatable bladder.

FIG. 5 is a perspective view of the airway assembly having a connector and an outer adapter.

FIG. 6 is a perspective view of a connector of the airway assembly of FIG. 5.

FIG. 7 is a perspective view of an outer adapter.

FIG. 8 is a perspective view of a capped outer adapter.

FIG. 9a illustrates a partial cutaway perspective view of the inflatable bladder of FIG. 1, showing a fan positioned within the interior area of the bladder, and an extension assembly that is operably connected to an outer adapter.

FIG. 9b illustrates a partial cutaway perspective view of the inflatable bladder of FIG. 1, showing a heater fan and thermostat positioned within the interior area of the bladder, and an extension assembly that is operably connected to an outer adapter.

FIG. 10 is a perspective view of the extension assembly of FIG. 3.

FIG. 11 is a perspective view of an inner adapter of an extension assembly of FIG. 3.

FIG. 12 is a perspective view of a mounting apparatus that may be used with certain embodiments of the present invention.

The foregoing summary, as well as the following detailed description of the preferred embodiments of the present invention, will be better understood when read in conjunction with the appended drawings. For the purpose of illustrating the preferred embodiments of the present invention, the drawings depict embodiments that are presently preferred. It should be understood, however, that the present invention is not limited to the arrangements and instrumentality shown in the attached drawings.

### DETAILED DESCRIPTION OF THE PREFERRED EMBODIMENT

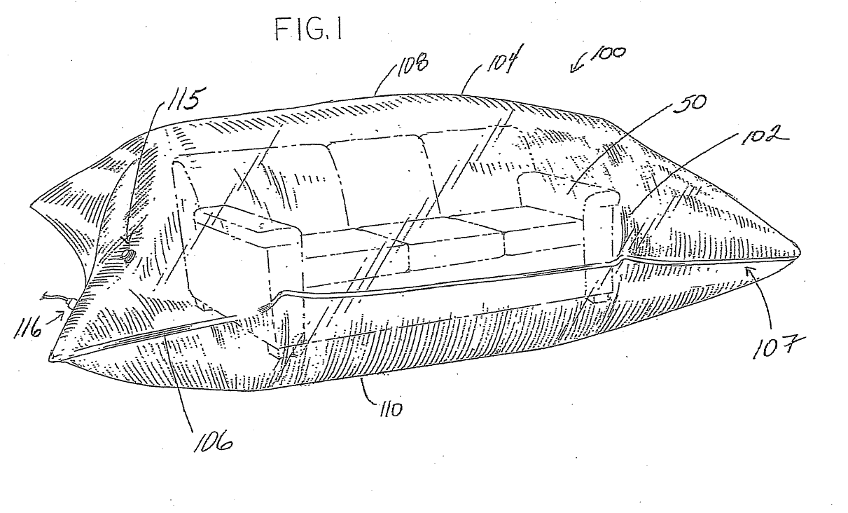

Referring to FIG. 1, an inflatable portable treatment device 100 includes an inflatable bladder 104 having an interior area 102 and a sealable opening 106 (shown in a closed sealed position in FIG. 1). Inflatable bladder 104 is configured so that one or more items, for example, a couch 50, may be placed within bladder 104 through opening 106, and then be positioned or located conveniently within interior area 102. When bladder 104 is closed via its opening 106, the item(s) within interior area 102 are encapsulated by bladder 104.

Bladder 104 may be constructed in a variety of sizes and configurations, including wall configurations that are generally rectangular, square, circular, triangular, and trapezoidal, among others. For example, when bladder 104 is deflated and laid flat, bladder 104 may have a generally rectangular shape and may be approximately eight feet long by six feet wide. According to another embodiment, bladder 104 may have a generally rectangular configuration that is approximately ten feet long by seven and a half feet wide. Additionally, according to other embodiments, the bladder may have a generally square configuration that is approximately four feet long by four feet wide. Inflatable bladder 104 may be constructed from a variety of different materials, including, for example, plastics such as, but not limited to, polyethylene and polythene. Bladder 104 may also include one or more holes or ports which may be configured to for the attachment of an outer adapter 150, as discussed below.

Inflatable bladder 104 may have two or more walls, including, for example, three walls, such as a base wall and two side walls. According to the embodiment illustrated in FIG. 1, inflatable bladder 104 has two walls, namely upper wall 108 and lower wall 110. Upper wall 108 is attached to lower wall 110 along three of the four sides of walls 108, 110, and forms a seal along the attached areas. For example, at least a portion of the upper wall 108 and the lower wall 110 may be molded or formed together along three of their sides, or may secured together along their three sides, through the use of an adhesive, solvents, hot gas weld, ultrasonic welding, laser weld, infrared welding, plastic welding, and pressure sensitive adhesives, among others. The continuous structure of inflatable bladder 104, with the seal created by the joining together of walls 108, 110 allows, when the opening 106 is closed, for the inflatable bladder 104 to be inflated and remain inflated. This structure allows an item to be placed within interior area 102 of inflatable bladder 104, so that the item may be treated.

Additionally, portions of walls 108, 110 may have varying thicknesses. For example, furniture or other items may be placed to rest against the lower wall 110 of inflatable bladder 104. Therefore, to prevent items inside interior area 102 from tearing, ripping, or puncturing lower wall 110, lower wall 110 may have a material thickness that is greater than other portions of inflatable bladder 104, such as for example, greater in thickness than wall 108. Additionally, one or more pads, such as felt pads, may be positioned beneath the feet or base of the item placed in interior area 102 to assist with preventing the item from tearing inflatable bladder 104 and/or to assist with moving or sliding the item within inflatable bladder 104. For example, individual felt pads may be positioned between one or more of the feet of couch 50 and inflatable bladder 104. Alternatively, a single felt pad may be positioned between a portion or the entire base or feet of the item placed in inflatable bladder 104.

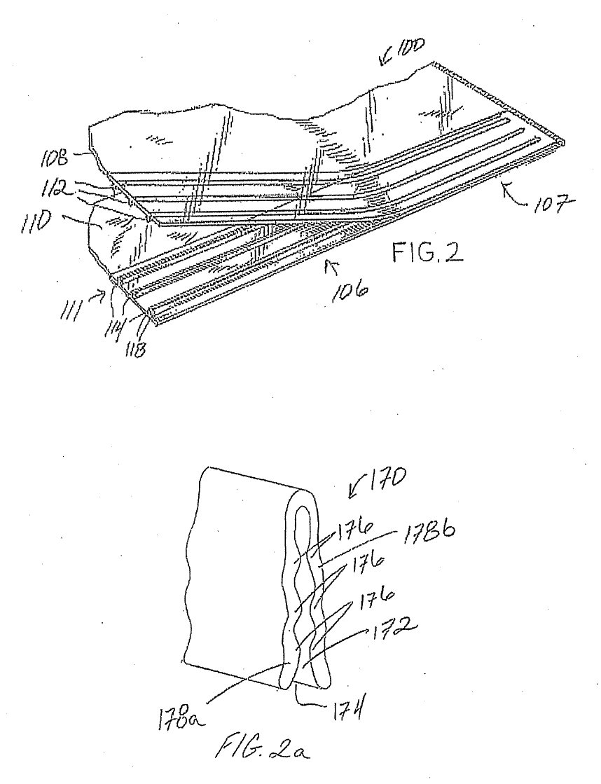

Referring to FIG. 2, opening 106 is formed along the fourth side 107 of inflatable bladder 104. An air seal, indicated by reference numeral 111 is formed along the side 107 by one or more ridges 112 and formed in, or attached to, upper wall 108 of inflatable bladder 104. Each ridge 112 mates with a corresponding raised recess 114 formed on lower wall 110. As shown in FIG. 2, each raised recess 114 includes a pair of sidewalls 118 separated by a space, the space being sized and configured to securely receive one ridge 112 upon the insertion of ridge 112 into the space between sidewalls 118. Ridges 112 and recesses 114 may be configured so that, when mated, such as by pressing ridge 112 into the spaces between sidewalls 118, ridge 112 and a recess 114 form a relatively air-tight seal so that gas inside the inflatable bladder 104 when bladder 104 is inflated does not pass through opening 106. Once the treatment process is complete, inflated bladder 104 may be deflated, such as, for example, by opening the air-seal by disengaging ridges 112 from recesses 114, and vice versa. When bladder 104 is to be inflated again for later treatments of the same or different item(s), opening 106 may again be closed by engaging ridges 112 and recesses 114 together. Although FIG. 2 illustrates three ridges 112 and three mating recesses 114, any number of ridges 112 and recesses 114 may be employed, such as for example, two ridges 112 and two mating recesses 114.

Although FIG. 2 illustrates the opening 106 being located along a single side of inflatable bladder 104, opening 106 may also be located at various positions along bladder 104. For example, opening 106 may be positioned in the top wall 108 of the inflatable bladder 104. According to such an embodiment, top wall 108 may include a flap, at least a portion of which is attached to top wall 108 to allow opening 106 to be opened while at least a portion of the flap remains attached to bladder 104. According to such an embodiment, the remainder of the flap may secured to top wall 108 through the use of mating ridges 112 and recesses 114, as discussed above, along the sides of the flap. Alternatively, the flap may be a separate component of bladder 104 and may be removed from bladder 104 and then secured to bladder 104 when opening 106 is to be closed.

FIG. 2a illustrates a perspective view of sealer clamp 170, which is configured to press the one or more ridges 112 and mating raised recesses 114 together to form air seal 111 when inflatable bladder 104 is closed. Interior portion 172 of sealer clamp 170 includes inlet 174 that is configured to allow interior portion 172 to be placed about at least a portion of upper and lower walls 108, 110 that has ridges 112 and recesses 114, respectively. Further, interior portion 172 may have a length that allows interior portion 172 to extend across each ridge 112 and mating recess 114. Interior portion 172 also includes opposing protrusions 176 in legs 178a, 178b of sealer clamp 170. When opening 106 is to be sealed closed, interior portion 172 is slid across ridge(s) 112 and recesses 114. As sealer clamp 170 is being slid, opposing protrusions 176 press ridge(s) 112 and/or recess(es) 114 that are adjacent to opposing protrusions 176 together, thereby closing opening 106 and forming the air seal.

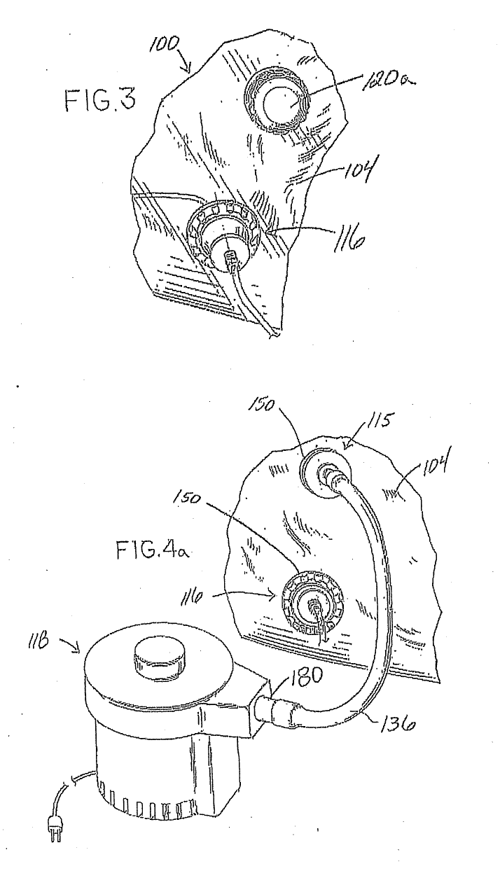

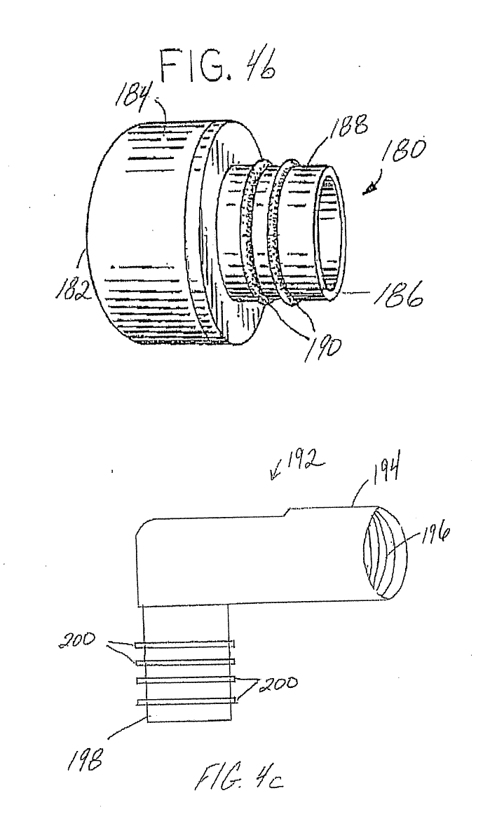

Referring to FIGS. 3 and 4, airway assembly 115 and electrical extension assembly 116 form part of the treatment device 100. According to an embodiment of the present invention, airway assembly 115 and extension assembly 116 may both be custom molded or custom manufactured and be adapted to be operably secured to bladder 104.

As shown in FIG. 4a, blower 118 is operably connected to airway assembly 115. When opening 106 is closed, airway assembly 115 provides an inlet for blower 118 to provide gas that passes through airway assembly 115 and into interior area 102 of bladder 104 so that bladder 104 may be inflated. With hose 136 connected to airway assembly 115 and blower 118, gas may be blown from blower 118 through hose 136 and air assembly 115, and into interior area 102 of inflatable bladder 104.

As shown in FIG. 4b, connector 180 may be attached to blower 118. For example, connector 180 includes first end 182 that may be secured to blower 118 by a mechanical fastener, press fit, or threaded engagement, among others. According to certain embodiments, first end 182 has first hub 184 that operably fits into an aperture in blower 118. However, according to other embodiments, first end 182 includes an aperture that mates with a tube, extension, or protrusion of blower 118. Connector 180 also includes second end 186 that has second hub 188 that has an outer diameter sized for a mating engagement with an internal surface of hose 136. Further, the second end of the connector 180 may also include one or more protrusions 190 used to secure hose 136 to second hub 188. According to certain embodiments, a hose clamp(s) may also be used to secure hose 136 to connector 180.

According to certain embodiments, rather than using blower 118, hose 136 may be connected to a pressurized tank or cylinder containing a gas used for poisoning vermin creature, such as, for example, carbon dioxide, argon, or other gases or chemicals. Such gas may be used in lieu of, or in addition to, chemicals placed or mounted within interior area 102 of inflatable bladder 104. For example, according to an embodiment, a pressurized gas tank or cylinder containing carbon dioxide may be operably connected to the inlet end of hose 136 such that the carbon dioxide is transported from the gas cylinder, through hose 136, and into interior area 102 of inflatable bladder 104. Further, hose 136 may be configured to accommodate the temperature of the gas released from the tank or cylinder. For example, because carbon dioxide released from a pressurized tank may typically have a low temperature, hose 136 may be constructed from a material that resists cracking in hose 136 due to such low temperatures. According to one embodiment, hose 136 may be a one-half inch diameter, four foot long, silicon pipe.

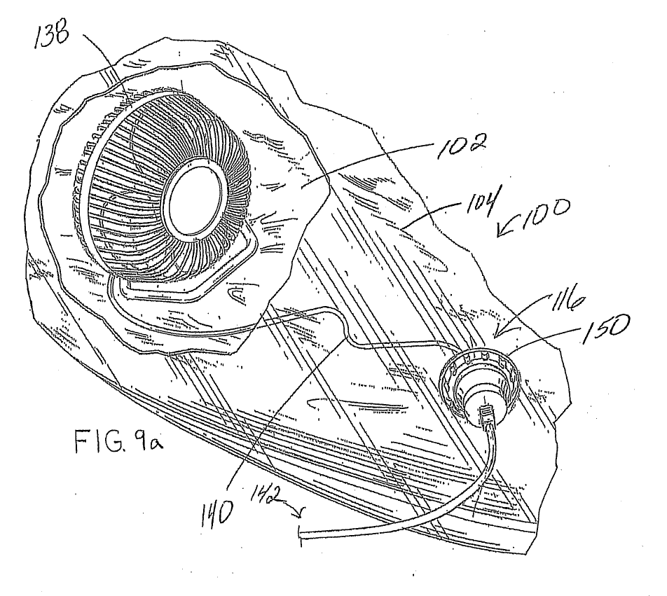

FIG. 4c illustrates gas connector 192 for connecting hose 136 to a gas tank. Connector 192 may be made of a variety of materials, including, for example being metallic. As shown, gas connector 192 has first end 194 having internal thread 196 that mates an internal threaded portion of a release valve on the gas tank. Gas connector 192 also has second end 198 configured for an operable connection with hose 136. For example, at least a portion of second end 198 of gas connector 182 has an outer diameter sized for a mating engagement with an internal surface of hose 136. Further, second end 198 of gas connector 192 may include one or more protrusions 200 to secure hose 136 to second end 198. According to certain embodiments, a hose clamp(s) may be used to secure hose 136 to gas connector 192. According to such embodiments, when gas is supplied to inflatable bladder 104 during treatment, portable treatment device 100 may or may not be configured for use with a fan 138 and/or heating element (discussed below). Thus, besides opening 106 of balder 104, certain embodiments only require a hole or port for use in the delivery of gas to bladder 104. Such holes or ports may also, when desired, be used to deflate bladder 104, such as, for example, by removing cap 120a, as shown in FIGS. 3 and 8, from outer adapter 150 that is positioned about a port, as discussed below.

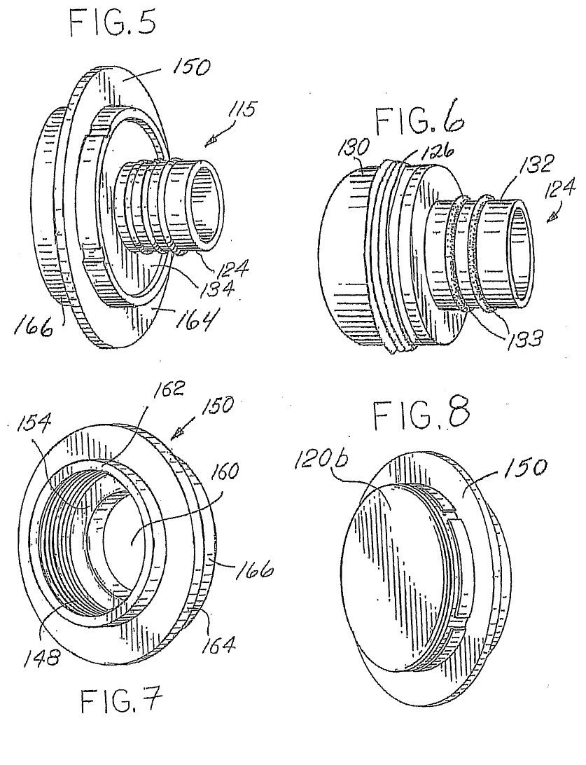

Referring to FIGS. 5-7, airway assembly 115 includes a connector 124 and an outer adapter 150. According to an embodiment of the present invention, connector 124 and outer adapter 150 may be custom molded or manufactured. Further, connector 124 and outer adapter 150 may be mechanically fastened together, such as through mating threads, a snap fit, the engagement of a threaded nut, retaining ring, or clamp, among others. Alternatively, the outer adapter 150 and connector 124 may be integrally molded together.

Referring to FIG. 6, connector 124 includes a cylindrical body portion 130 and a cylindrical coupler 132. Connector 124 provides a passageway for gas to pass through at least a portion of air assembly 115. Body portion 130 of connector 124 is configured to be received into a cylindrical aperture 148 (FIG. 7) in outer adapter 150. In particular, the outer surface of coupler 132 may have an external thread 126 that mates with an internal thread in aperture 148 of outer assembly 150.

Coupler 132 is configured so that an end of hose 136 (FIG. 4a) may be placed, or pushed, over coupler 132. Hose 136 may have a variety of different shapes and sizes, such as, for example, having a generally cylindrical shape that has a diameter of approximately 21 mm and is 2 feet long. Coupler 132 includes at least one protrusion 133 (two protrusions are shown) that assist in preventing the end of hose 136 from inadvertently sliding off of coupler 132. For example, protrusion 133 may have a diameter slightly larger than the diameter of coupler 132 that assists in creating an interference that prevents hose 136 from inadvertently disengaging from the coupler 132. With respect to the end of hose 136 that is connected to blower 118, hose 136 may be connected to the blower 118 in a variety of different ways. For example, hose 136 may be connected to blower 118 by pushing or inserting an end of hose 136 into or onto a port or tube of blower 118, or hose 136 may be attached to blower 118 by a connector similar to connector 136 illustrated in FIG. 6, and/or by the use of a hose clamp, among other connections.

FIG. 7 illustrates a perspective view of outer adapter 150. Outer adapter 150 may include an aperture 148, an inner surface 154, an orifice 160, a ring 162, a rim 164, and a hub 166. Orifice 160 of outer adapter 150 may provide an opening through which gas may be blown through the outer adapter 150 portion of the airway assembly 115 and into interior area 102 of bladder 104. Further, orifice 160 may provide a space through which an extension cord can be connected to electrical extension assembly 116, as discussed below. As previously discussed, aperture 148 may have an internal thread that mates with an external thread 126 on connector 124.

Outer adapter 150 is operably secured to upper wall 108 of inflatable bladder 104, such as, for example, by a plastic weld, hot gas weld, ultrasonic welding, laser weld, infrared welding, plastic welding, molding, or through the use of an adhesive or a mechanical fastening arrangement. Further, bladder 104 may include an opening or port through which at least a portion of hub 166 may pass into bladder 104, and which provides a passageway for gas to pass through at least a portion of outer adapter 150 and into bladder 104. As shown in by FIGS. 3 and 4, one or more outer adapters 150 may be connected to bladder 104, which may be used for the airway assembly 115 and/or electrical extension assembly 116.

According to an embodiment, hub 166 of outer adapter 150 has external threads and is configured to be inserted into a hole (not shown) in upper wall 108 of inflatable bladder 104. Further, rim 164 has a diameter larger than the diameter of hub 166 so that rim 164 is unable to fit through the hole in bladder 104. Hub 166 may be inserted through the orifice and into the interior area 102 of bladder 104 so that the upper wall 108 of inflatable bladder 104 is positioned against the backside of rim 164. A mating nut (not shown) that is larger than the orifice in bladder 104 may be positioned on the threaded hub 166 and tightened so as to securely trap a portion of upper wall 108 between the nut and the backside of the rim 164 to both secure the airway assembly 115 to bladder 104 and create a seal that prevents or minimizes the undesired passage of gas out from the bladder through or the associated orifice when the bladder is inflated. Additionally, washers or other sealers (not shown) may be used to assist in preventing the undesired passage of gas from the connection area defined between the airway assembly 115 and inflatable bladder 104.

According to another embodiment, airway assembly 115 may engage a mating surface in wall 108 of inflatable bladder 104. For example, a disc may be formed directly into, or attached to wall 108. Such a disc provides an opening with an internal shape or diameter through which outer adapter 150 may be inserted and secured to bladder 104, as for example, through the use of an adhesive, mechanical fastener, interference fit, snap fit, a clip fit, or through the use of a threaded engagement, among others. Again, additional washers or sealers may also be used to assist in preventing or minimizing gas from escaping from inflatable bladder 104, when inflated, in the connection area surrounding outer adapter 150.

Referring to FIGS. 3 and 8, when blower 118 is disconnected from airway assembly 115, connector 124 may be removed from outer adapter 150, and a cap 120a, 120b may be placed on or in outer adapter 150 to prevent undesired outward flow of gas (which may be air that includes fumigant and/or pesticide vapor or agent, or be a non-poisonous gas such as carbon dioxide) from inflatable bladder 104. According to an embodiment of the present invention, cap 120a may be custom molded or manufactured to mate with outer adapter 150. According to an embodiment of the present invention, outer adapter 150, connector 124, and cap 120a, 120b may be manufactured from a variety of different materials, including, for example, metal and plastic, among others.

Referencing FIG. 3, cap 120a may be threaded into outer adapter 150 until a back wall of cap 120a abuts against inner surface 154 of outer adapter 150. The abutment of a portion of cap 120a against inner surface 154 may create a seal between cap 120a and outer adapter 150 that prevents or minimizes gas from escaping from interior area 102 through outer adapter 150. Additionally, cap 120a or outer adapter 150 may include additional seals or washers that may assist in preventing or minimizing gas from escaping from interior area 102. Further, as shown in FIG. 3, an outer surface of cap 120a may include a plurality of grooves, ridges, and/or raised protrusions that may provide a surface at which a user may be able to grip cap 120a so as to tighten, or loosen, cap 120a to/from outer adapter 150.

According to another embodiment, as shown in FIG. 8, a cap 120b may be sized to snap or clip into outer adapter 150. For example, aperture 148 (FIG. 7) of outer adapter 150 and at least a portion of cap 120b may be configured so that cap 120b snaps or clips into outer adapter 150. For example, according to certain embodiments, inflatable bladder 104 may be discarded after a single treatment. Therefore, cap 120b and/or outer adapter 150 may include arms having inwardly or outwardly extending protrusions that engage a surface of the outer adapter 150 and/or cap 120b when cap 120b is inserted into outer adapter 150. Such arms and protrusions may allow the cap 120b to be securely positioned in outer adapter 150 to prevent or minimize the undesired escaping of gas from the interior area 102 of the inflated inflatable bladder 104 through outer adapter 150. However, according to other embodiments, cap 120b may be removable so that the treatment device 100 may be used multiple times, or in the event gas has escaped from the inner area 102, to re-connect the connector 124 to outer adapter 150 to re-form airway assembly 115 so as to provide additional gas from blower 118 to re-inflate inflatable bladder 104 to a desired level of inflation. According to certain embodiments, cap 120b is secured to outer adapter 150 by external threads on cap 120b that engage internal threads on outer adapter 150. According to such embodiments, cap 120b may also include one or more recesses or other surface modifications along an outer surface of cap 120b. Such recesses may be configured to facilitate a user's ability to grasp cap 120b as cap 120b is rotated to tighten or loosen the engagement between the external threads of cap 120b and the internal threads of outer adapter 150.

According to another embodiment, rather than using cap 120a, airway assembly 115 and/or outer adapter 150 may include a check valve that may open to allow gas to be blown into bladder 104, and close when gas is not being blown into bladder 104 so as to prevent the gas, which, again, may include fumigant and/or pesticide vapors or chemical agent in air, or be a non-poisonous gas such as carbon dioxide, from escaping from inside bladder 104. Additionally, bladder 104 may have a separate check valve that may release gas from inside interior area 102 when pressure inside inflatable bladder 104 reaches a certain limit so as to prevent bladder 104 from popping, tearing, or ripping.

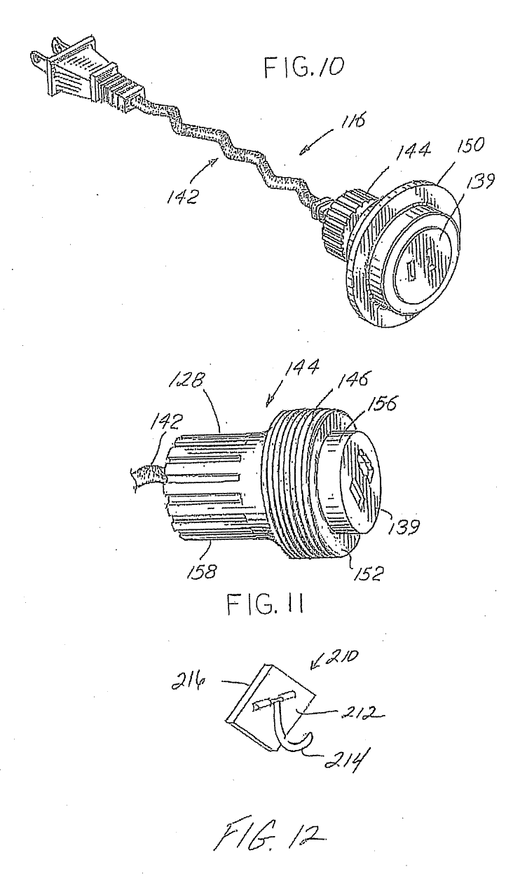

Alternatively, rather than using a cap 120a, 120b, after bladder 104 has been inflated and airway assembly 115 has been disassembled by the removal of connector 124 from outer adapter 150, that same outer adapter 150 may be connected to inner adapter 144 (FIG. 11) to provide electrical extension assembly 116, discussed below, which is also configured to prevent or minimize the escape of gas from inflated bladder 104 through outer adapter 150.

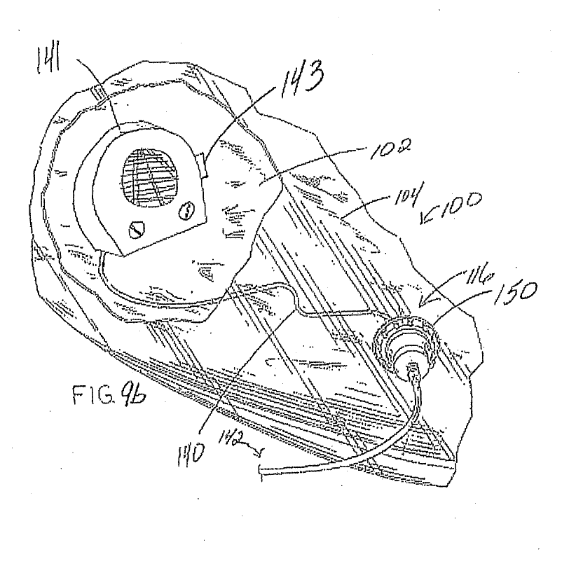

Referring to FIG. 9a, a portable fan 138 is positioned in interior area 102 of inflatable bladder 104 and is operably connected to electrical extension assembly 116. Extension assembly 116 provides a power outlet to operate fan 138 within the interior area 102 of inflatable bladder 104 while also providing a seal that prevents or minimizes gas from escaping from the interior area 102. Additionally, extension assembly 116 is operably connected to extension cord 142 that may be plugged into a source of electricity, such as, for example, a powered wall outlet that typically provides 110 volts or 220 volts of electricity. The extension cord 142, which may be custom molded or manufactured, is operably connected to extension assembly 116 so that extension cord 142 delivers power from an electrical source (not shown) to extension assembly 116.

FIG. 9b illustrates a partial cutaway perspective view of inflatable bladder 104 of FIG. 1, showing heater fan 141 and thermostat 143 positioned within interior area 102 of bladder 104, and extension assembly 116 that is operably connected to outer adapter 150. Alternatively, according to certain embodiments, heater fan 141 may be a heating element, such as a heating coil or space heater, among others, that is placed with fan 138 within interior area 102, or may be part of fan 138. In embodiments in which the heating element is a component separate from fan 138, the heating element may be powered through the use of an electrical extension assembly 116 separate from that used by the fan 138. Alternatively, the electrical extension assembly 116 may have more than one female plug that is configured to receive the insertion of a male plug of fan 138 and the heating element.

According to the embodiment illustrated in FIG. 9b, heater fan 141 may be connected to thermostat 143. Thermostat 143 may be configured to sense when operation of heater fan 141 should be paused and/or ceased, which may occur when thermostat 143 reaches a predetermined temperature or temperature range.

The heating element may increase the temperature within interior area 102 so as to increase the respiratory activity of the vermin creature, which may increase the rate at which the vermin creature inhales or ingests the chemical agent or harmful gas. Additionally, the movement of the vermin creature may increase with an increase in temperature in interior region 102, which may reduce the time period before the vermin creature encounters the chemical agent or harmful gas, or increase the amount of agent or harmful gas that the vermin creature encounters.

Referring to FIGS. 10 and 11, extension assembly 116 includes inner adapter 144 and outer adapter 150. According to certain embodiments, outer adapter 150 used with extension assembly 116 may be the same outer adapter 150 used for airway assembly 115, with the connector 124 being replaced by inner adapter 144. Alternatively, airway assembly 115 may have an outer adapter 150 that is not the same outer adapter 150 as used by extension assembly 116.

Inner adapter 144 includes electrical plug receiving socked 139, which is oriented towards the interior area 102 of the inflatable bladder 104. Extension assembly 116 provides a socket 139 for receiving a power cord 140 (FIG. 9) to deliver electricity to fan 138.

Inner adapter 144 may also include a body 128, first hub 156, threaded section 146, and second hub 158. Inner adapter 144 may have an integral construction, or may be constructed through the connection of different components. For example, electrical plug receiving socked 139, which may or may not include threaded section 146, may be a separate component that is pressed into, mechanically fastened, or adhered to body 128 of inner adapter 144.

Orifice 160 of outer adapter 150 is configured to receive at least a portion of first hub 156 (FIG. 11) of inner adapter 144 so as to provide access to socket 139 when inner adapter 144 is engaged with outer adapter 150. Additionally, threaded section 146 of inner adapter 144 mates with an internal thread in aperture 148 of outer adapter 150. Inner adapter 144 may be inserted into outer adapter 150 until a face 152 of inner adapter 144 abuts and/or is pressed against inner surface 154 of outer adapter 150 so as to assist in creating a seal that prevents and/or minimizes gas from inflated bladder 104 from passing through outer adapter 150. Further, a gasket may be pressed between face 152 and inner surface 154 when threaded section 146 is tightened relative to outer adapter 150 so as to provide a seal that prevents or minimizes the undesired escaping of gas from the interior area 102 through the connection between the inner and outer adapters 144, 150. The gasket may be a separate, individual component, or may be secured adjacent to inner adapter 144, such as, for example, in front of threaded section 146. Alternatively, the gasket may be secured to outer adapter 150, such as about inner surface 154. The gasket may be made from a variety of different materials, including, for example, rubber or plastic.

Second hub 158 of inner adapter 144 is configured for operable connection to extension cord 142. Extension cord 142 is electronically connected to socket 139, such as, for example, being hard wired to socket 139. Alternatively, second hub 158 may include electrically conductive male prongs or female slots that are operably connected to socket 139, and which mate with the corresponding slots or prongs of extension cord 142 that allow extension cord 142 to be removably connected to second hub 158. Alternatively, inner adapter 144 may include a seal which fits around at least a portion of the extension cord 142 that prevents gas from escaping through inner adapter 144 when the inflatable bladder 104 is inflated while also allowing power cord 140 of fan 138 to be directly operably connected to extension cord 142.

During operation, the item to be treated, such as for example couch 50 shown in FIG. 1, may be inserted through opening 106 and placed in the interior area 102 of inflatable bladder 104. Fan 138 may also be placed inside the interior area 102 of bladder 104. Fan 138 may be positioned within the interior area 102 at a variety of locations, such as in a corner of area 102, among other locations, and oriented so that the fumigant and/or pesticide vapor or chemical agent is propelled toward the item that is to be treated. Additionally, fan 138 may include a receptacle, such as, for example, a hook or perforated container, among others, disposed in front of the fan cage and/or fan blades, that is configured to receive and/or hold a chemical agent, such as, for example, Nuvan Prostrips™, which includes as an active fumigation chemical 2,2 Dichlorovinyl dimethyl phosphate, or VAPONA®, among other chemical agents. By placing the chemical agent in the receptacle in front of the fan blades, the fan blades propel gas through the chemical agent to create a fumigant and/or pesticide vapor or propel the agent into the gas of bladder 104. Power cord 140 of the fan is then plugged into socket 139 of extension assembly 116, the extension assembly 116 being secured to the treatment device 100 by an outer adapter 150.

FIG. 12 is a perspective view of mounting apparatus 210, which may be used with certain embodiments of the present invention. Various types of chemical agents, or packaging or containers containing the chemical agent, may be attached to and/or hung from mounting apparatus 210 during the treatment process. As shown in FIG. 12, according to certain embodiments, mounting apparatus 210 may include front side 212, to which hook 214 is mounted, and rear side 216, which has or is attached to an adhesive material, such as, for example, double sided tape. Mounting apparatus 210 may be mounted at a number of different locations within interior area 102 of inflatable bladder 104, including, for example, on upper wall 108, fan 138, the heating element, and/or on the item being treated, among other locations.

According to another embodiment, the chemical agent may enter the interior area 102 through an aperture or port in the inflatable bladder 104, and then be circulated by the fan 138 about the interior area 102. For example, the chemical agent may be forced into the interior area 102 via gas flow into the interior area 102. Alternatively, other methods of providing the chemical agent within the interior area may be used, such as for example, placing a canister, container, or dispenser, among others, in or about interior area 102 that may be provide, store, or release the chemical agent. The fan 138 may still circulate at least a portion of the chemical agent about the interior area 102. According to another embodiment, the gas blown into the interior area 102 may be a non-poisonous gas, such as carbon dioxide, that may be employed to treat an item in interior area 102 with or without using a separate chemical agent.

The opened sides of the inflatable bladder 104, providing opening 106, may be sealed closed. Hose 136 of the blower 118 is attached to connector 124 of airway assembly 115, which has been secured to inflatable bladder 104, so as to blow gas into the interior area 102 of inflatable bladder 104 According to another embodiment, as previously discussed, the gas blown into interior area 102 may be a non-poisonous gas, such as carbon dioxide. Once inflatable bladder 104 has reached a desired level of inflation, blower 118 may be turned off and connector 124 may be removed from outer adapter 150. A cap 120a, 120b may then be used to close outer adapter 150 so as to prevent or minimize the escaping of gas from the interior area 102. Extension cord 142 of extension assembly 116 may then be plugged into a power source, such as a 120 volt or 220 volt wall outlet, so as to provide power to the socket 139, and thus provide power to operate fan 138. As previously described, the operation of fan 138 will cause the fan blades to propel gas through the chemical agent to create a fumigant and/or pesticide vapor or propel the chemical agent that treats the item inside interior area 102 of inflatable bladder 104.

Once the chemical treatment process has ended, and the chemical agent has been in contact with the treated item for the requisite time period, inflatable bladder 104 is deflated by opening 106, puncturing inflatable bladder 104, or removing cap 120a, 120b and applying a vacuum or suction force to remove the gas and/or fumigation and/or pesticide vapor or agent from interior area 102 through airway assembly 115.

According to certain embodiments, inflatable portable treatment device 100 may be provided as a kit. The number of ports or holes in one or more inflatable bladders 104, such as, for example two bladders 104, that are provided with the kit, and the associated number of outer adapters 150, may depend on which of the following are included, or otherwise used, with the kit: blower 118, fan 138, heater fan 144 (or a heating element), and/or a gas tank containing a gas used for poisoning vermin creature. Such a selection may also influence whether the kit includes or is to be used with one or more electrical extension assemblies 116, gas connector 192, hose 136 (as well as the type of hose 136), and mounting apparatus 210. Further, the kit may or may not also include a chemical agent used in the extermination of the vermin creatures. Thus, the particular components of the kit may depend on the devices used in the treatment process. At least a portion of the kit may be provided in a container that allows for storing at least a portion of the kit components together in the container.

While the invention has been described with reference to a preferred embodiment, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. An inflatable, portable treatment device for the treatment of an item comprising:
an inflatable bladder having an interior area, said interior area configured to receive the placement of an item to be treated;
an airway assembly attached to said inflatable bladder, said airway assembly having a connector configured for connection to a hose that delivers gas to said airway assembly, said airway assembly configured to pass delivered gas to said interior area;
an electrical extension assembly operably attached to said inflatable bladder, said electrical extension assembly having an electrical socket and an electrical cord, said electrical extension assembly configured to prevent the escape of gas from said interior area through said electrical extension assembly when said inflatable bladder is inflated; and
a fan operably positioned in the interior area of said inflatable bladder, said fan having a power cord, said electrical socket configured to receive the insertion of a plug on the power cord of said fan, said fan disposed to circulate gas within said interior area when said inflatable bladder is inflated.

2. The apparatus of claim 1, wherein the gas passed to the interior area is carbon dioxide.

3. The apparatus of claim 2 wherein said airway assembly further includes an outer adapter, said outer adapter attached to said inflatable bladder, said connector being removable from said outer adapter.

4. The apparatus of claim 2 wherein said extension assembly includes an inner adapter and an outer adapter, said socket positioned on an inner face of the inner adapter, said inner adapter also operably connected to said extension cord, said extension cord configured to deliver of electrical power to said socket.

5. The apparatus of claim 1, wherein said fan is also disposed to circulate a chemical agent for extermination of vermin creature within said interior area.

6. The apparatus of claim 5 further including a mounting apparatus for hanging the chemical agent that is to be circulated about said interior area.

7. The apparatus of claim 1, further including a heating element positioned in said interior area to heat the circulated gas.

8. The apparatus of claim 1, wherein said fan is a heater fan.

9. The apparatus of claim 1 wherein said inflatable treatment device includes an opening, said opening being closed by an air seal that prevents the passage of gas from said interior area through said opening when said inflatable bladder is inflated and said opening is closed.

10. The apparatus of claim 9 wherein said inflatable bladder is comprised of an upper wall and a lower wall, at least a portion of said upper wall being operably connected to at least a portion of said lower wall, said lower wall having a material thickness greater than the material thickness of said upper wall.

11. An inflatable, portable treatment device for the treatment of an item, comprising:
an inflatable bladder having an opening and an interior area, said opening configured to allow the passage of an item to be treated into said interior area, said opening being closed by an air seal that prevents the passage of gas from said interior area through said opening when said inflatable bladder is inflated and said opening is closed;
an airway assembly attached to said inflatable treatment device, said airway assembly having a connector configured for connection to a hose that delivers gas through said airway assembly and into said interior area; and
a gas tank configured to contain gas to treat the item, said gas tank also configured to be operably connected to a gas connector, said gas connector configured to be attached to said hose to deliver the gas to said interior area.

12. The apparatus of claim 11 wherein said inflatable bladder is comprised of an upper wall and a lower wall, at least a portion of said upper wall operably connected to at least a portion of said lower wall, said lower wall having a material thickness greater than the material thickness of said upper wall.

13. The apparatus of claim 11 further including a check valve operably attached to said inflatable bladder, said check valve configured to release gas said interior area when pressure within said interior area reaches a predetermined level.

14. The apparatus of claim 11 further including a chemical agent for extermination of vermin creature positioned within said interior area.

15. A method for treating an item with a chemical agent, comprising:
positioning the item in an interior area of an inflatable bladder;
attaching a connector to a first outer adapter to provide an airway assembly, the first outer adapter attached to the inflatable bladder;
attaching an inner adapter to a second outer adapter to provide an electrical extension assembly, the electrical extension assembly configured to prevent the passage of gas from the interior area through the second outer adapter, the second outer adapter attached to the inflatable bladder;
connecting an extension cord of the electrical extension assembly to a power source, the electrical extension assembly having an electrical socket operably connected to a power cord of the fan;
sealing an opening of the inflatable bladder to prevent the passage of gas from the interior area through the opening;
connecting a gas delivery apparatus to the airway assembly;
inflating the inflatable bladder by the delivery of gas by the gas delivery apparatus through the airway assembly and into the interior area; and
sealing the airway assembly to prevent the passage of gas from the interior area through the first outer adapter.

16. The method of claim 15 further including the steps of:
inserting the item through the opening and into the interior space; and
positioning a chemical agent for the treatment of vermin creature in the interior area.

17. The method of claim 15, wherein the step of sealing the opening further includes inserting a ridge on an upper wall of the inflatable bladder into a mating raised recess on a lower wall of the inflatable bladder.

18. The method of claim 15 wherein the step of sealing the airway assembly includes placing a cap on the first outer adapter.

19. A portable treatment kit comprising:
at least one inflatable bladder, the at least one inflatable bladder having an interior area and an opening, said interior area configured to receive the placement of an item to be treated, said opening being closed by an air seal that prevents the passage of gas from said interior area through said opening when said inflatable bladder is inflated, said seal having one or more ridges and one or more mating recesses that, when mated, provide an air seal;
a hose used in the delivery of gas to said interior area at least when said inflatable bladder is being inflated; and
an airway assembly attached to said inflatable bladder, said airway assembly having a connector configured for connection to said hose, said airway assembly configured to pass gas delivered by said hose to said interior area.

20. The portable treatment kit of claim 19 further including:
an electrical extension assembly operably attached to said inflatable bladder, said electrical extension assembly having an electrical socket and an electrical cord, said electrical extension assembly configured to prevent the escape of gas from said interior area through said electrical extension assembly when said inflatable bladder is inflated; and
a heater fan configured to be positioned in said interior area of said inflatable bladder, said heater fan having a power cord, said electrical socket configured to receive the insertion of a plug on the power cord of said heater fan, said heater fan disposed to circulate gas within said interior area when said inflatable bladder is inflated.

21. The portable treatment kit of claim 20 further including a chemical agent for extermination of vermin creature within said interior area.

22. The portable treatment kit of claim 19 further including a blower configured to be attached to a first end of said hose, a second end of said hose being connected to said airway assembly, said blower configured to inflate said inflatable bladder by the delivery of gas by the blower through the hose and airway assembly and into said interior area.

23. The portable treatment kit of claim 22 further including a chemical agent for extermination of vermin creature within said interior area.

24. The portable treatment kit of claim 19 further including a gas tank configured contain gas to poison vermin creature, said gas tank also configured to be operably connected to said hose.

25. The portable treatment kit of claim 24 further including a chemical agent for extermination of vermin creature within said interior area.

26. The portable treatment kit of claim 19, further including a felt pad for placement beneath at least a portion of the item to be treated.
